(19) United States
(12) Patent Application Publication
(10) Pub. No.: US 2013/0271404 A1
(43) Pub. Date: Oct. 17, 2013

(54) REMOTE CONTROLLER EQUIPPED WITH TOUCH PAD AND METHOD FOR CONTROLLING THE SAME

(71) Applicant: LG ELECTRONICS INC., Seoul (KR)

(72) Inventors: Kwangho CHOI, Pyeongtaek-si (KR); Byunglok JEON, Pyeongtaek-si (KR); Sihwa PARK, Pyeongtaek-si (KR); Kyoungju RYU, Pyeongtaek-si (KR); Taeuk KIM, Pyeongtaek-si (KR)

(73) Assignee: LG Electronics Inc., Seoul (KR)

(21) Appl. No.: 13/856,709

(22) Filed: Apr. 4, 2013

(30) Foreign Application Priority Data
Apr. 12, 2012 (KR) 10-2012-0037736

(51) Int. Cl. G06F 3/01

(52) U.S. Cl. CPC G06F 3/01
USPC 345/173

(57) ABSTRACT

A remote controller having a touch pad according to an embodiment of the present invention includes a wireless communication unit transmitting a signal to and receiving a signal from a display device, a touch pad receiving a user input signal for controlling the display device, a sensor unit comprising a motion detecting sensor and sensing information about motion of the remote controller, a storage storing data necessary for operating or controlling the remote controller, and a controller controlling, when the user input signal is received in the touch pad, the motion detecting sensor of the sensor unit to disenable signal transmission of the motion detecting sensor in response to the user input signal.

Pursuant to 35 U.S.C. §119(a), this application claims the benefit of Korean Patent Application No. 10-2012-0037736, filed on Apr. 12, 2012, which is hereby incorporated by reference as if fully set forth herein.

### BACKGROUND OF THE INVENTION

1. Field of the Invention

The present invention relates to a remote controller equipped with a touch pad and a method for controlling the same, and more particularly, a remote controller equipped with a touch pad controlling a display device effectively by disenabling signal transmission by a Gyro sensor when the touch pad is in use and a method for the same. The display device, for example, includes a network TV, smart TV, HBBTV (Hybrid Broadcast Broadband Television), internet TV, web TV, IPTV (Internet Protocol Television), and etc.

2. Discussion of the Related Art

Generally, various display devices including a TV and VCR provides a remote controller that can control remotely to improve user convenience and such a remote controller includes various buttons to operate the display devices. For example, in case of a remote controller for TV, buttons for operating channel-change and audio-change are equipped such that viewing TV can be performed.

Meanwhile, recently a touch pad is equipped in various display devices which are becoming “convergence” for convenience for additional functions such as scroll and drag and drop such that not only digital TVs for interactive communications between viewers and broadcast program providers but also various multimedia contents can be provided.

Also, the display devices including TVs that can display contents can not only simply receive broadcast signals and display broadcast programs but also perform various internet functions such as email, web browsing, banking and game, and accordingly, the remote controller is now being used as a mouse of a personal computer.

FIG. 1 is a view illustrating an embodiment of a prior art remote controller controlling a display device. A display device (10) like a Smart TV can control efficiently through a pointer (21) corresponding to a remote controller (20). To improve user convenience, the remote controller (20) can be equipped with a touch pad and, as shown in FIG. 1, a button-shaped user input menu in the touch pad can be equipped to receive user input.

However, in case that the remote controller (20) is used, a gyro sensor for controlling the display device (10) through the pointer (21) corresponding to the remote controller (20) will be always operated. Accordingly, it is problematic that the pointer gets out of bound due to the user's hand shaking occurred when pressing a button like a Confirm button.

FIG. 2 is a view illustrating another embodiment of a prior art remote controller controlling a prior display device. In the process of controlling the display device (10) through the remote controller, when the pointer corresponding to the remote controller moves to the end corner of the screen, an end menu (11) will be popped up and displayed as shown in FIG. 2, and when the pointer moves to the top corner, a top information window (12) will be displayed. This happening will take place when a gyro sensor is simultaneously operated by using the touch pad. Accordingly, in case that the prior art remote controller is used, the pointer corresponding to the remote controller causes side effects (11, 12) by unintentionally moving to the top and end corners.

FIG. 3 is a view illustrating another embodiment of a prior art remote controller controlling a display device. In case of the prior art remote controller, because the gyro sensor is in operation at all times, it is problematic that the pointer (21) corresponding to the remote controller (20) becomes activated even when users who are holding the remote controller do not want to activate it, as shown in FIG. 3.

### SUMMARY OF THE INVENTION

An embodiment of the present invention provides a remote controller and a method of improving user convenience by reducing chances for the pointer corresponding to the remote controller to unintentionally move.

Also, another embodiment of the present invention provides a remote controller and a method of reducing user inconvenience by gyro sensor movements by disenabling the motion of the gyro sensor when a touch pad is in use.

The remote controller having the touch pad according to an embodiment of the present invention includes a wireless communication unit receiving and transmitting signals with a display device, a touch pad receiving a user input signal from a user for controlling the display device, a sensor unit sensing information including a gyro sensor about the operation of the remote controller, a storage storing data necessary for operating or controlling the remote controller, and a controller controlling such that the signal transmission of the gyro sensor can be disenabled in response to the user input signal when the user input signal is received in the touch pad.

And, the method of controlling a remote controller having a touch pad includes transmitting a gyro sensor signal to a display device, receiving a touch signal from a user through the touch pad, disenabling the transmitting the gyro sensor signal if the touch signal is sensed, transmitting the touch signal to the display device, and restoring disenabling the transmitting the gyro sensor signal if the touch signal is restored.

A method of controlling a remote controller having a touch pad includes transmitting to a display device a signal sensed in a motion detecting sensor, detecting a first signal indicating a disenabled status of the motion detecting sensor, if the first signal is detected, controlling such that the signal sensed in the motion detecting sensor cannot be transmitted to the display device, detecting a second signal indicating an enabled status of the motion detecting sensor; and if the second signal is detected, controlling such that the signal sensed in the motion detecting sensor can be transmitted to the display device.

According to an embodiment of the present invention, user convenience can be improved by reducing chances for the pointer, corresponding to the remote controller, to not move unintentionally.

Also, according to another embodiment of the present invention, user inconvenience by the gyro sensor operation can be reduced by disenabling the gyro sensor movements when the touch pad is in use.

More detailed description about the advantageous effects of the present invention will be illustrated in the following.

### BRIEF DESCRIPTION OF THE DRAWINGS

FIG. 1 is a view illustrating an embodiment of a prior art remote controller controlling a display device;

FIG. 2 is a view illustrating another embodiment of a prior art remote controller controlling a display device;

FIG. 3 is a view illustrating another embodiment of a prior art remote controller controlling a display device;

FIG. 4 is a view of a system using a controller according to an embodiment of the present invention.

FIG. 5 is a block diagram of a display device controlling a remote controller according to the present invention;

FIG. 6 is a view illustrating an exterior of a remote controller controlling a display device according to an embodiment of the present invention;

FIG. 7 is a block diagram of a remote controller according to an embodiment of the present invention;

FIG. 8 is a block diagram of a remote controller according to an embodiment of the present invention;

FIG. 9 is a view illustrating a side view of an embodiment using a remote controller shown in FIG. 8.

FIG. 10 is a view illustrating a side view of another embodiment using a remote controller shown in FIG. 8.

FIG. 11 is a view illustrating an embodiment of a remote controller controlling a touch pad and gyro sensor jointly.

FIG. 12 is a front and side views of a remote controller according to an embodiment of the present invention.

FIG. 13 is a view illustrating an embodiment of a receivable pattern in a remote controller according to the present invention.

FIG. 14 to FIG. 19 are views illustrating embodiments of control signals corresponding to patterns identified in a remote controller according to the present invention.

FIG. 20 is a flowchart of a controlling method of a remote controller having a touch pad according to an embodiment of the present invention.

FIG. 21 is a flowchart of a controlling method of a remote controller having a touch pad according to another embodiment of the present invention.

FIG. 22 is a flowchart of a controlling method of a remote controller having a touch pad according to another embodiment of the present invention.

FIG. 23 is a view illustrating an embodiment of an information message window applicable for the flowchart of the controlling method shown in FIG. 22.

FIG. 24 is a flowchart of a controlling method of a remote controller having a touch pad according to another embodiment of the present invention.

FIG. 25 is a view of an embodiment of a first signal applicable for a remote controller according to the present invention.

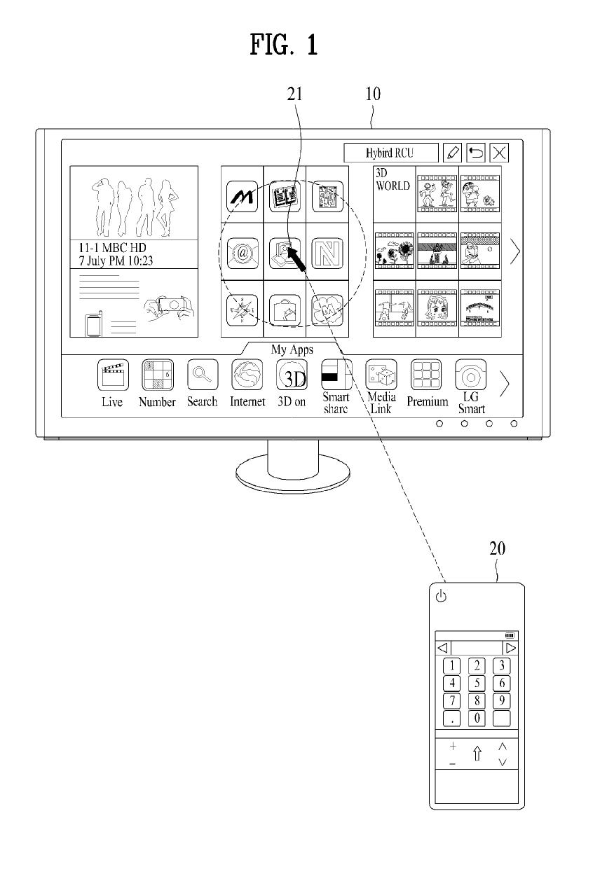

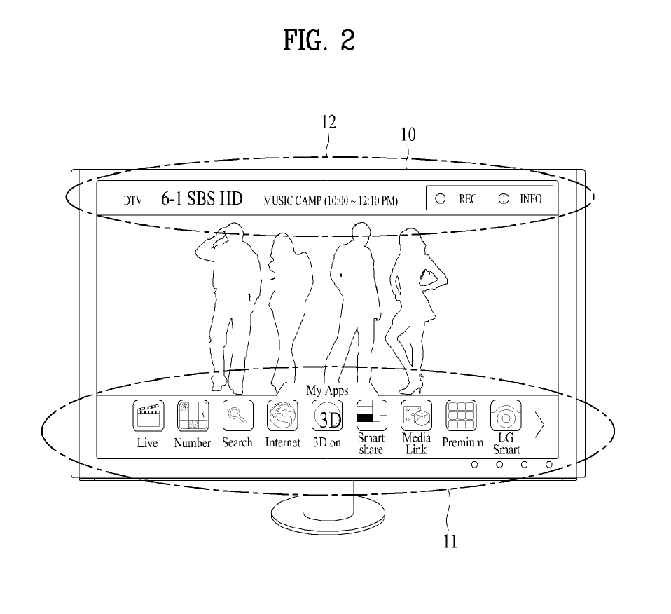

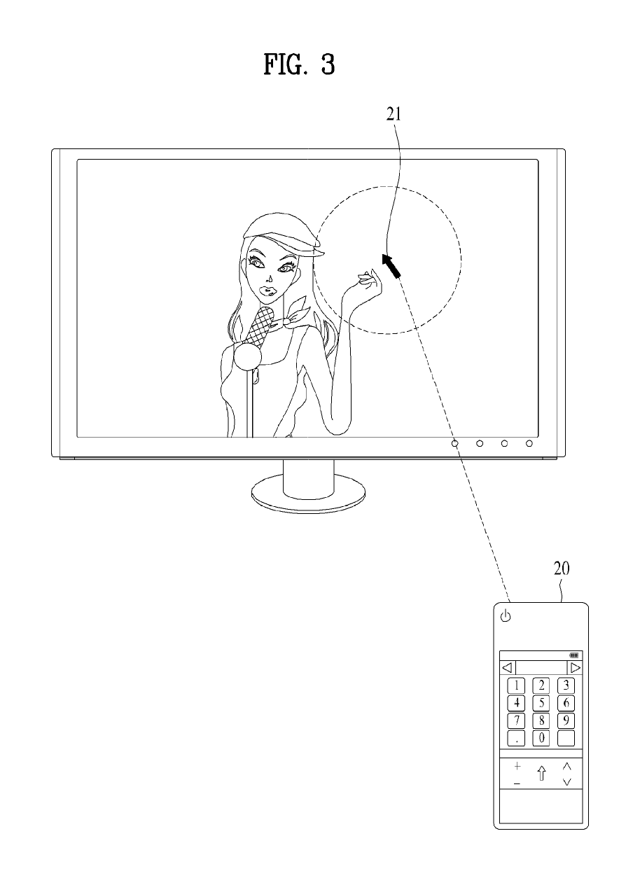

### DETAILED DESCRIPTION OF THE INVENTION

The present invention will be described in detail in reference with the views hereinafter.

Suffixes “module” and “unit” of components used in the following description are given merely for the convenience of explanation. The “module” and “unit” may be used interchangeably.

Also, although general terms widely used considering functions in the present invention have been selected in the present invention, they may be changed depending on intention of those skilled in the art, practices, or new technology. Also, in specific cases, the applicant may optionally select the terms. In this case, the meaning of the terms will be described in detail in the description part of the invention. Therefore, it is to be understood that the terms should be defined based upon their meaning not their simple title and the whole description of the present invention.

Furthermore, although embodiments of the present invention will be described in detail with reference to the accompanying views and content of the views, the present invention is not limited or restricted only by such embodiments.

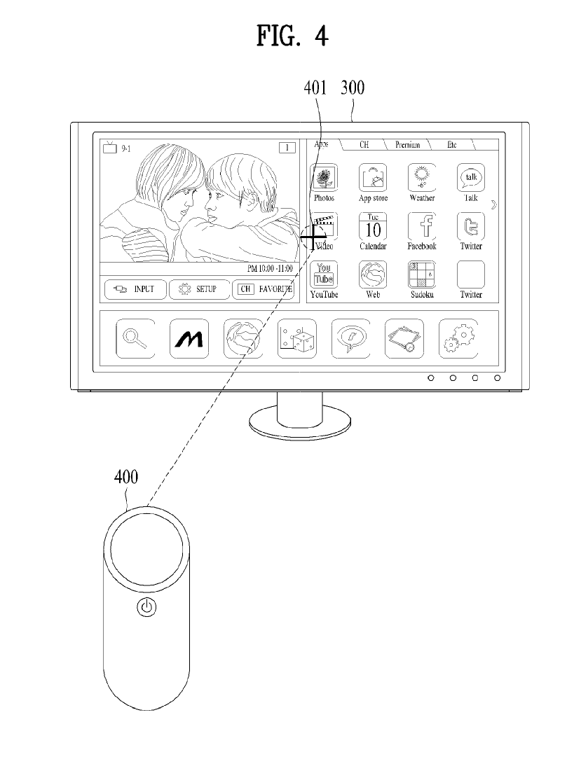

FIG. 4 is a view of a system using a controller according to an embodiment of the present invention. As shown in FIG. 4, the system can include a display device (300) and a remote controller (400) remotely controlling the display device (300). The display device is controlled by a pointer (401) corresponding to the remote controller (400).

The display device (300), as an intelligent network TV with an additional computer supporting function embedded in broadcast receiving functions, can be equipped with a more convenient interface including internet functions performing broadcast receiving functions than a handwriting input device, touch screen or space remote controller. And by connecting to internet or computer by wired or wireless internet functions, various functions such as email, web-browsing, banking or gaming can be performed. The standardized general purpose operating systems can be used for these various functions. Accordingly, the display device illustrated in the present invention can freely add or delete various applications in the standardized operating system kernel so that various user friendly functions can be performed.

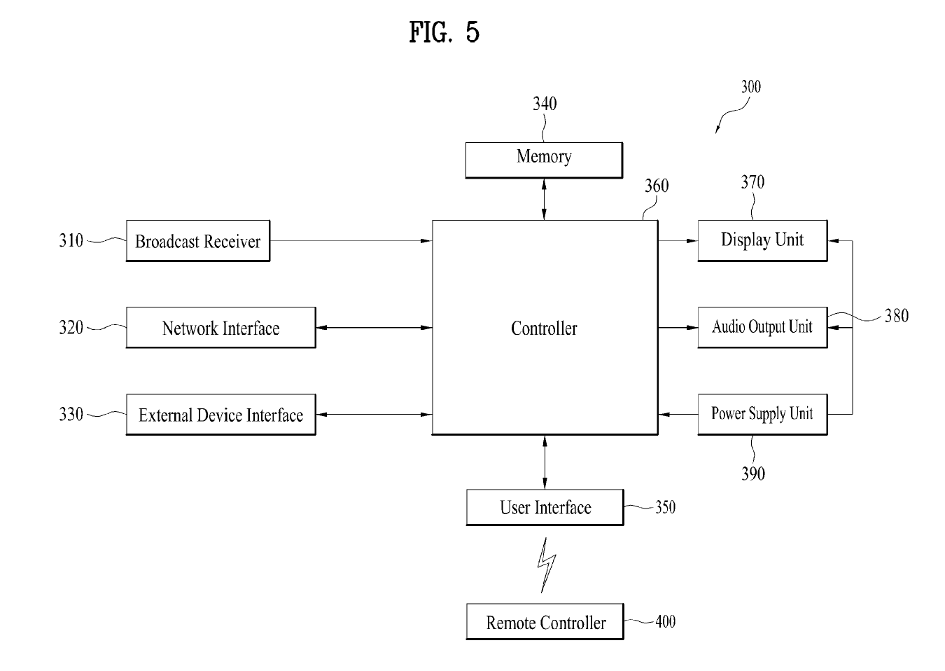

FIG. 5 is a block diagram of a display device controlling a remote controller according to the present invention. As shown in FIG. 5, the display device (300) according to an embodiment of the present invention includes a broadcast receiver (310), network interface (320), external device interface (330), storage (340), user interface (350), controller (360), display unit (370), audio output unit (380), and power supply unit (390).

The broadcast receiver (310) includes a tuner (not shown), demodulator (not shown), and network interface (320). Clearly, depending on the necessity, it is possible to be designed with the tuner and demodulator but the network interface (320) or with the network interface (320) but the tuner and demodulator.

The tuner selects an RF (Radio Frequency) broadcast signal included in all channels predetermined or selected by the user among RF signals received through antenna. The demodulator receives and demodulates digital IF signals (DIF) converted in the tuner.

Stream signals outputted in the demodulator may be inputted to the controller (360).

The external device interface (330) may be connected to the external device and the network device. For doing so, the external device interface (330) can include an A/V input/output unit (not shown) or wireless communications (not shown).

The external device interface (330) may be connected wired or wireless to external devices such as a DVD (Digital Versatile Disk), BD (blu-ray Disk) player, game console, camera, camcorder, and computer (laptop). Also, the external device interface (330) receives applications or application lists in the proximity of the external device and transmits them to the controller (360) or storage (340).

The network interface (320) may be equipped with an Ethernet port for connecting to wired network. Also, for connecting to wireless network, communications standards such as WLAN (Wireless LAN) (Wi-Fi), Wibro (Wireless Broadband), Wimax (World Interoperability for Microwave Access), and HSDPA (High Speed Downlink Packet Access) may be used. Also, the network interface (320) may select and receive one of the applications open to the public through network.

The storage (340) may be realized by EEPROM (Electrically Erasable Programmable Read-Only Memory), store programs for processing and controlling signals in the controller (360), and store video, audio, and data signals which are signal-processed.

Also, the storage (340) may perform a function to temporarily store video, audio, and data signals inputted from the external device interface (330) or network interface (320). Furthermore, the storage (340) may store applications or application lists inputted from the external device interface (330) or network interface (320).

The user interface (350) transmits signals inputted by the user to the controller (360) or signals from the controller (360) to the user. For example, the user interface (350) receives and processes input signals for power On/Off, channel selection, screen setting from the remote controller (400) or processes such that control signals from the controller (360) can be transmitted to the remote controller (400) depending on various communications methods such as a RF (Radio Frequency) communications method and IR communications method.

The display unit (370) generates actuating signals by converting into R,G,B signals video signals, data signals, and OSD signals processed in the controller (360), or video signals and data signals received in the external device interface (330). The display unit (370) may display in PDP, LCD, OLED, Flexible Display, and 3D display.

The audio output unit (380) receives audio processed signals such as stereo signals, 3.1 channel signals, or 5.1 channel signals and outputs them in audio. The audio output unit (380) can be realized in various types of speakers.

The power supply unit (390) supplies power to the display device (300) in overall. For example, power can be supplied to the controller (360) realized as a type of System On Chip (SOC), the display unit (370) for video display, and audio output unit (380) for audio output.

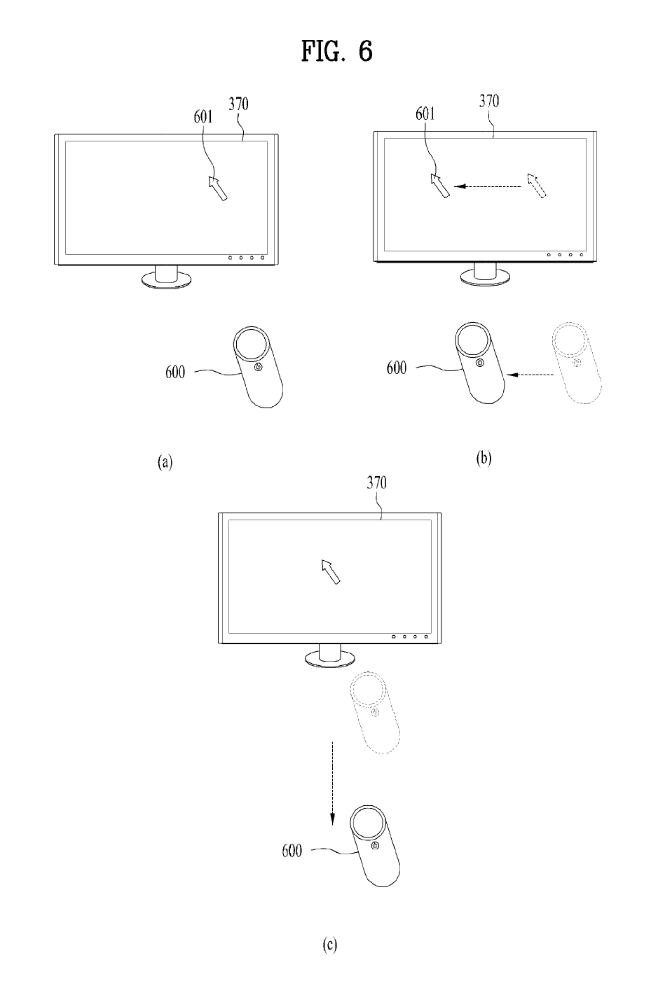

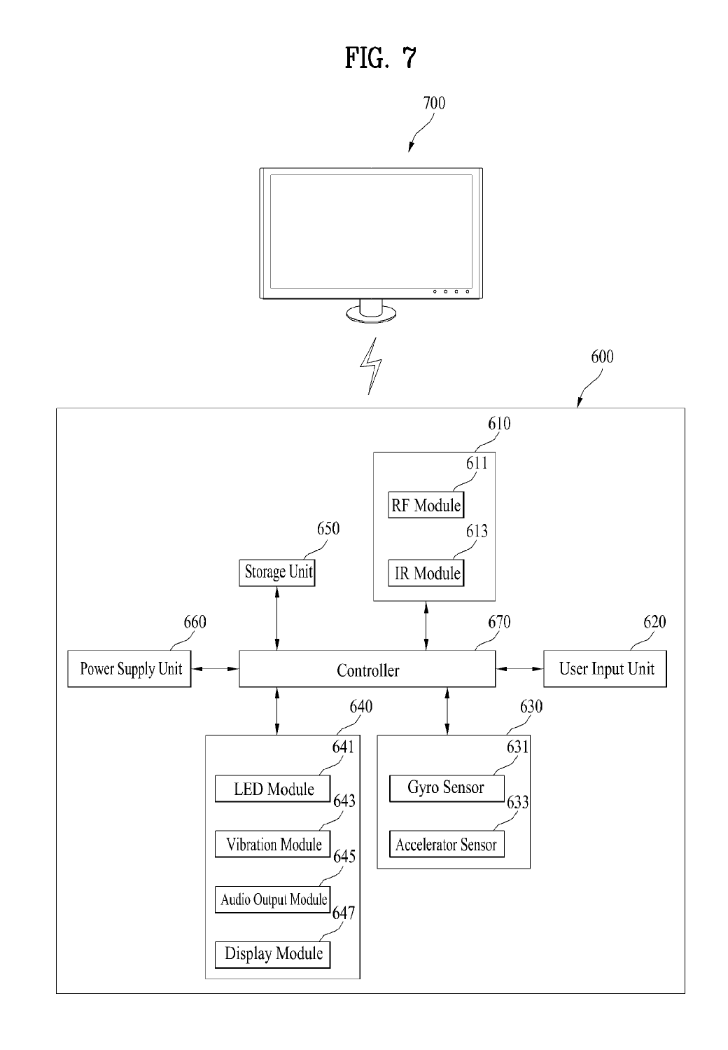

The remote controller (400) transmits user input to the user interface (350). For doing so, the remote controller (400) may use a Bluetooth, RF communications, IR communications, UWB (Ultra Wideband), and ZigBee. Especially, the remote controller (400) will be further described with reference to FIG. 6 and FIG. 7.

FIG. 6 is a view illustrating an exterior of a remote controller controlling a display device according to an embodiment of the present invention, the description of the remote controller controlling the display device according to an embodiment of the present invention with reference to FIG. 6 is as follows.

First of all, as shown in FIG. 6(a), a pointer (601) corresponding to a remote controller (600) in the display device is exemplified. Moreover, the display unit (370) shown in FIG. 6 complies with the display unit of the display device shown in FIG. 5.

The user may move the remote controller (600) in the vertical, horizontal, left, right (FIG. 6(b)), front, and behind (FIG. 6(b)) directions and rotate. The pointer (601) indicated in the display unit (370) of the display device corresponds to the operation of the remote controller (600). Such a remote controller (600), as shown in the view, may be named a space remote controller because the pointer (601) moves and displays depending on the operation in 3D.

FIG. 6(b) is an example that when the user moves the remote controller (600) to the left, the pointer (601) indicated in the display unit (370) of the display device also moves to the left in compliance.

Information about the operation of the remote controller (600) sensed by the sensor of the remote controller (600) can be transmitted to the display device. The display device may compute a coordination of the pointer (601) from information about the operation of the remote controller (600). The display device may indicate the pointer (601) corresponding to the computed coordination.

FIG. 6(c) is an example that the user moves the remote controller (600) away from the display unit (370) with a specified button in the remote controller (600) pressed. Accordingly, the selected area in the display unit (370) corresponding to the pointer (601) may be displayed zoomed-in. On the other hand, when the user moves the remote controller (600) closer to the display unit (370), the selected area in the display unit (370) corresponding to the pointer (601) will be displayed zoomed-out.

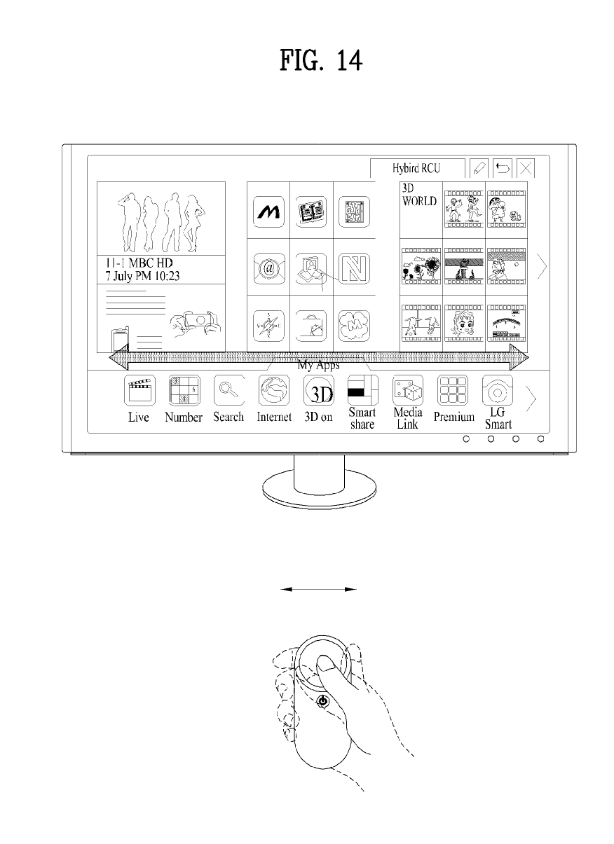

Accordingly, when the remote controller shown in FIG. 6 moves, it is effective that icons and menu selections displayed in the display device can be quickly and conveniently selected. By using the touch pad, selecting and controlling menus and icons indicated in the display device will be further described in FIG. 14 to FIG. 19.

FIG. 7 is a block diagram of a remote controller according to an embodiment of the present invention and illustrates a detailed configured module of the remote controller shown in FIG. 6. Yet, FIG. 7 is an embodiment of the present invention and, depending on the user's necessities, a part of the configured module may be deleted or a new configured module may be added as a protective range of the present invention.

Shown in FIG. 7, the remote controller (600) includes a wireless communications unit (610), user input (620), sensor (630), output unit (640), power supply unit (660), storage unit (650), and controller (670), and the wireless communications unit (610) receives and transmits signals with one of the display devices in the aforementioned embodiments of the present invention.

In an embodiment of the present invention, the remote controller (600) may be equipped with the RF module (611) that can transmit and receive signals with the display device (700) according to the RF communications standards. Also, the remote controller (600) may be equipped with the IR module (613) that can transmit and receive signals with the display device (700) according to the IR communications standards.

In an embodiment of the present invention, the remote controller (600) transmits to the display device (700) signals including information about the operation of the remote controller (600).

Also, the remote controller (600) may receive the signals transmitted by the display device (700) through the RF module (611). Also, the remote controller (600) may transmit to the display device (700) commands relating to power On/Off, channel-change, and volume-change through the IR module (613), if needed.

The user input unit (620) may be composed of a keypad, button, touch pad, or touch screen, and the touch pad is exemplified in the present invention. The user may input to the remote controller (600) commands relating to the display device (700) through the touch pad.

The sensor (630) may be equipped with the gyro sensor (631) or accelerator (633). As an embodiment, the gyro sensor (631) may sense information about the movements of the remote controller (600) in the X, Y, Z, axis. Accordingly, corresponding to the movements of the remote controller (600), the pointer corresponding to the remote controller (600) may move together. The accelerator (633) may sense information about a velocity of the remote controller (600). On the other hand, a distance measurement sensor may be further equipped so that distance from the display device (700) can be sensed.

The output unit (640) may output video or audio signals corresponding to the signals transmitted from the display device (700) or the operation of the user input unit (620). The user may sense whether or not the user input unit (620) is operated or the display device (700) is controlled through the output unit (640).

As an embodiment, the output unit (640) may be equipped with a LED module (641) which will be lit when signals are received from or transmitted to the display device (700) through the wireless communications unit (610) or the user input unit (620) is operated, a vibration module (643) generating vibrations, audio output module (645) outputting audio, or display module (647) outputting video.

The power supply unit (660) supplies power to the remote controller (600). The power supply unit (660) may reduce power waste by restoring the power supply during a predetermined period of time when the remote controller (600) does not move. The power supply unit (660) may re-supply power when a predetermined key mounted on the remote controller (600) is operated.

The storage (650) may store various programs and application data necessary for controlling or operating the remote controller (600). If the remote controller (600) transmits or receives signals through the display device (700) and RF module (611), the remote controller (600) and display device transmits signals through a predetermined range of frequency.

The controller unit (670) controls all matters related to controlling the remote controller (600). The control unit (670) may transmit to the display device (700) signals corresponding to the operation of the remote controller (600) sensed by the sensor (630) or signals corresponding to the predetermined key operations of the user input unit (620) through the wireless communications unit (610).

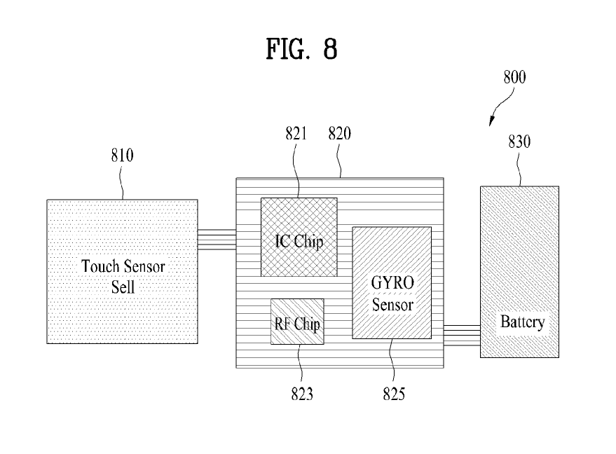

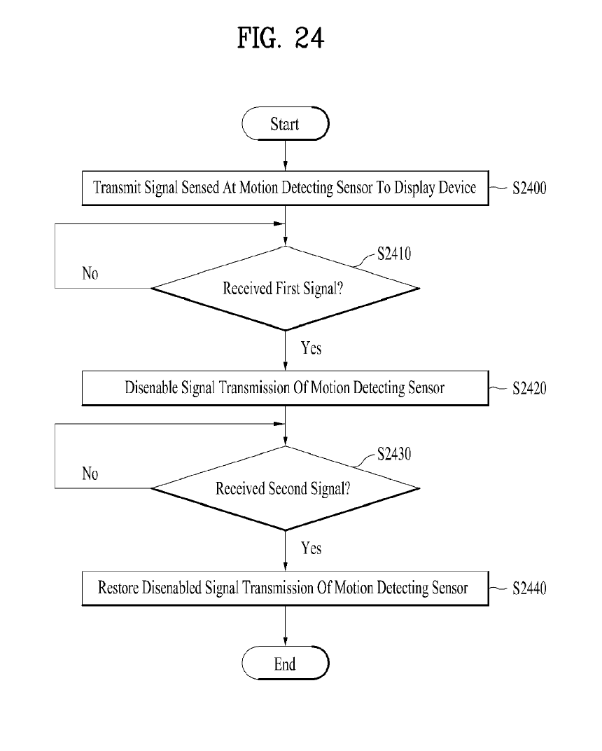

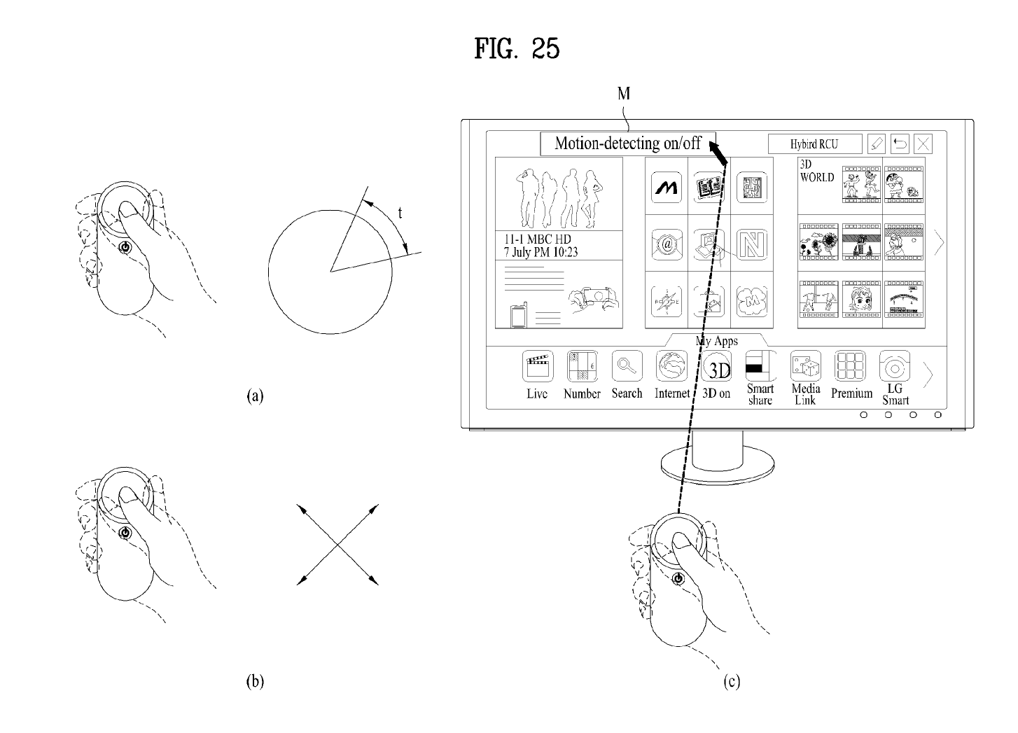

Also, when the user input signal is received in the touch pad, the control unit (670) controls such that the signal transmission of the gyro sensor (630) corresponding to the input signal can be disenabled. For example, the control unit (670) disenables the signal transmission of the gyro sensor by receiving as a user input signal a touch signal in the touch pad, and controls such that disenabling the signal transmission of the gyro sensor can be restored by receiving as a user input signal a touch-release signal of the touch pad. With regard to that, it will be further described in FIG. 8 to FIG. 10. Also, the control unit (670) disenables the signal transmission of the gyro sensor by receiving from the touch pad as a user input signal a signal indicating the disabled status of the gyro sensor, and restores disenabling the signal transmission of the gyro sensor by receiving a signal indicating the enabled status of the gyro sensor. With regard to that, it will be described in FIG. 24 to FIG. 25 as follows.

FIG. 8 is a block diagram of a remote controller according to an embodiment of the present invention. As shown in FIG. 8, the remote controller (800) may include a touch pad (810) having touch sensor cells for receiving touch signal input from the user, a Printed Circuit Board (PCB) including various chips and electronic components for controlling the remote controller transmitting signals to and receiving signals from the display device, and a battery (830) for supplying power to the remote controller (800).

A gyro sensor unit (825) for sensing a movement value of the remote controller (800), RF communications unit (823) for transmitting a location value to the display device through the gyro sensor, and a controller unit (821) controlling transmitting and receiving signals and executing various remote controller commands are arranged in the printed circuit board.

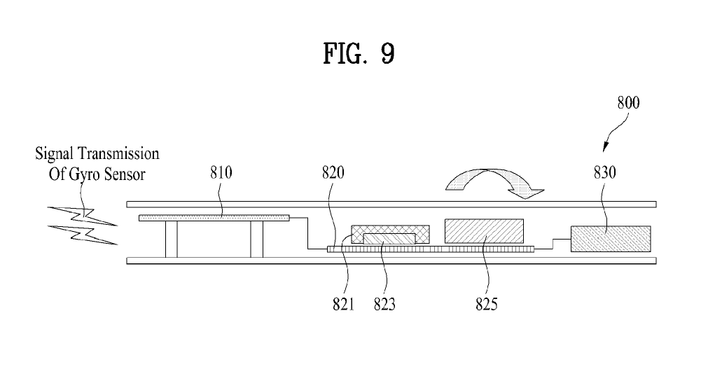

FIG. 9 is a view illustrating a side view of an embodiment of the remote controller shown in FIG. 8 and an embodiment of transmitting a location value of the gyro sensor according to the movement of the remote controller shown in FIG. 8. When the remote controller (800) is moved by the user, the location value of the gyro sensor may be transmitted to the display device through the RF communications unit (823).

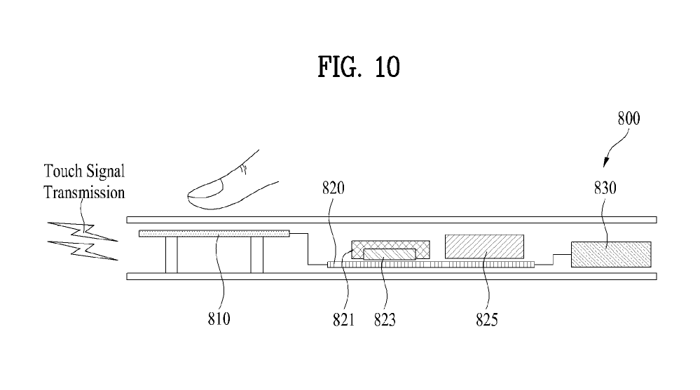

FIG. 10 is a view illustrating a side view of another embodiment of using the remote controller shown in FIG. 8 and an embodiment of controlling the remote controller in case that the user inputs a touch signal through the touch pad (810) in the remote controller shown in FIG. 8.

The controller unit (821) disenables the transmission of the location value of the gyro sensor when an electric signal in the touch sensor, that is, the user's hand touching is sensed, and transmits only signals about the touch command to the RF communications unit (823). Accordingly, as soon as the electric signal of the touch sensor stops, that is, the hand touching is disconnected, the control unit (821) restores disenabling the transmission of the location value of the gyro sensor and transmits the value of the gyro sensor to the RF communications unit (823).

As such, when the user uses the touch pad, it is effective that the pointer, corresponding to the remote controller, does not move out of the bound due to the vertical shaking of the hand caused by the user's touching the touch pad as a display control according to the sensing of the gyro sensor is stopped.

Also, in case that the user touches the touch pad, it happens that when the gyro sensor is also in operation, the pointer corresponding to the remote controller unintentionally moves to and displays the bottom menu, and the user's viewing TV can be interrupted. However, as aforementioned, when a command is being transmitted through the touch pad, by disenabling the signal restoration of the gyro sensor, the problem can be reduced.

In addition, it was problematic that the pointer corresponding to the remote controller was displayed and interrupted viewing TV because the gyro sensor in the prior art remote controller was always in operation even when the user held onto the remote controller and did not want to display. However, according to an embodiment of the present invention, user convenience may be improved because the pointer is not displayed unwanted even if the user holds onto the remote controller and uses the display device for disenabling the transmission of the location value of the gyro sensor when the user touches the touch pad. Such an advantage can be applied to not only viewing live broadcast through the display device but also using the home menu, web-surfing, and gaming.

Yet, in case that the user uses the remote controller, it may happen that the gyro sensor can be unintentionally used by the user's habit of the user's hand touching the touch pad. In such a case, user inconvenience may be similarly reduced by disenabling the transmission of the location value of the gyro sensor.

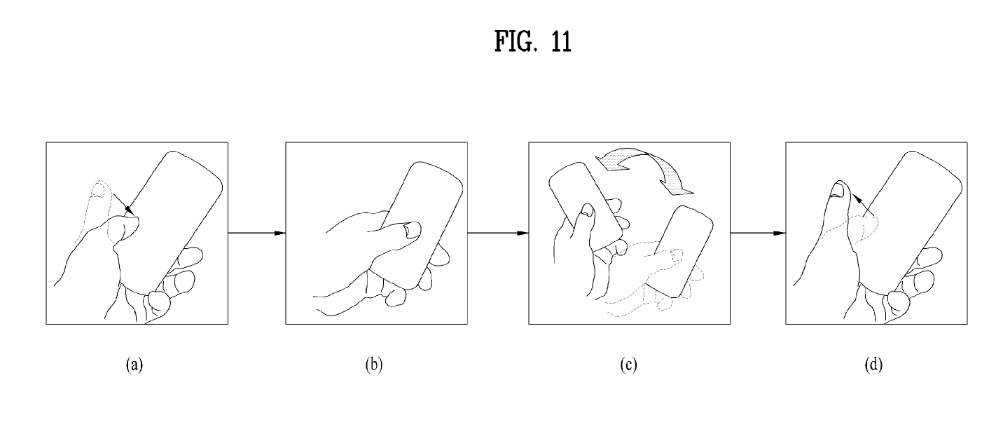

Accordingly, in case that the duration of the touch signal of the touch pad exceeds a predetermined time limit, the controller of the remote controller controls such that disenabling the signal transmission of the gyro sensor can be restored and the transmission of the touch signal can be restored. With regard to that, it will be described in detail with reference to FIG. 11.

FIG. 11 is a view illustrating an embodiment of controlling in case that a touch pad and gyro sensor are jointly used in a remote controller according to an embodiment of the present invention.

When the user's hand is in contact with the touch pad as shown in FIG. 11(a), the touch pad determines that a user input signal is received. Accordingly, the signal transmission of the gyro sensor corresponding to the inputted touch signal will be disenabled and as shown in FIG. 11(b) the touch signal according to the touch pad will be transmitted to the display device. Thus, in such a case, although the user moves the remote controller, the location value of the gyro sensor will not be transmitted to the display device, and the pointer corresponding to the remote controller displayed in the display device will not be displayed or moved.

Yet, when the touch signal continuously exceeds a predetermined period of time limit, disenabling the signal transmission of the gyro sensor will be restored and the transmission of the touch signal will be disenabled. In case that the touch signal continuously stays over a predetermined period of time, it is reasonable to consider that the display device is being controlled not by the user's habit. Accordingly, when the user moves the remote controller shown in FIG. 11, the location value of the gyro sensor corresponding to the movement will be transmitted to the display device. In such a case, the transmission of the touch signal by the touch pad has been disenabled.

However, although the transmission of the touch signal is disenabled, if the touch-release signal is sensed, that is, the contact of the user's hand is restored as shown in FIG. 11(d), the control unit of the remote controller restores the disenabling transmission of the touch signal. It is because, then, when the touch signal is sensed later, a command according to that can be transmitted to the display device.

In such a case, when the user unintentionally keeps the user's hand in contact with the touch pad the touch command is automatically disenabled by the controller unit, but when statics is detected by continuously detecting the statics by the touch, that is, when the user disenables the contact of the user's hand, the touch command will be re-activated. Accordingly, it is advantageous that an unintentional command by the user will not be transmitted through the remote controller because the touch pad and the gyro sensor will not operate at the same time.

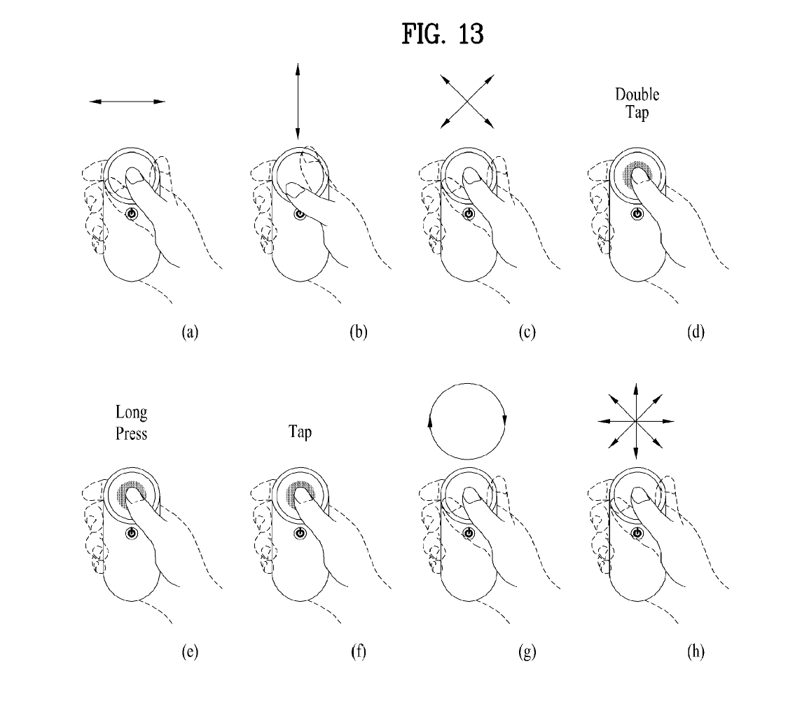

On the other hand, the remote controller according to the present invention may further include a pattern recognizing part recognizing a pattern in the touch signal received through the touch pad. The storage (650) shown in FIG. 7 stores a receivable pattern through the touch pad and control signals corresponding to the pattern, and the controller (670) extracts the control signal corresponding to the recognized pattern in the pattern recognizing part, and transmits the control signal to the display device. With regard to such, it will be described with reference to FIG. 13 to FIG. 19.

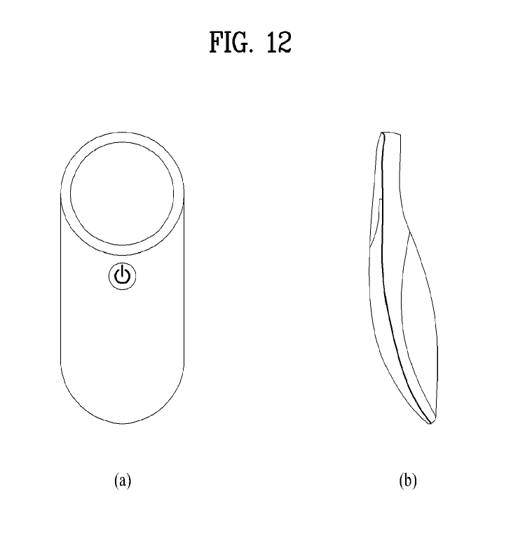

Yet, an embodiment of a remote controller for easily transmitting control signals through a previous pattern is illustrated. FIG. 12(a) is a front view of a remote controller according to an embodiment of the present invention and FIG. 12(b) is a side view of a remote controller according to an embodiment of the present invention. The embodiment of the remote controller shown in FIG. 12 has a convenient volume and size for the user to grab and is equipped with a touch pad for inputting a pattern by a thumb when the user grabs the remote controller. Accordingly, FIG. 13 to FIG. 19 illustrate embodiments of transmitting to the display device control signals corresponding to the pattern inputted in the touch pad by using the remote controller shown in FIG. 12. However, the remote controller is not limited to its shape in FIG. 12 but any shapes if the touch pad is equipped with it.

FIG. 13 is a view illustrating an embodiment of a receivable pattern in a remote controller according to the present invention and describes an embodiment of the receivable pattern as an embodiment of the remote controller shown in FIG. 12.

As shown in FIG. 13, the user may set a specified pattern that moves horizontally (FIG. 13(a)), vertically (FIG. 13(b)), and diagonally (FIG. 13(c)) on the touch pad. Also, unlike FIG. 13(a) to (c), a pattern (FIG. 13(d)) touching the touch pad twice without direction, a pattern (FIG. 13(e)) pressing once long, and a pattern (FIG. 13(h)) pressing once short may be set. Also, a pattern that draws a circle as shown in FIG. 13(g) may be set. Also, as shown in FIG. 13(h), a specified pattern for all directions may be set.

On the other hand, in order to set such a specified pattern corresponding to a control signal, the control signal includes at least a power control signal of the display device, channel-change control signal, volume-change control signal, zoom control signal of a screen, capture control signal of the screen, and screen page control signal.

FIG. 14 to FIG. 19 are views illustrating embodiments of a control signal corresponding to a pattern recognized in a remote controller according to the present invention, and describes the control signal corresponding to the recognized pattern with reference to FIG. 14 to FIG. 19. But, as embodiments, FIG. 14 to FIG. 19 are not limited to such a pattern and a control signal may be set differently corresponding to the patter or added.

FIG. 14 is a view illustrating an embodiment of sensing the touch signal in the horizontal direction as a screen page control signal turning a menu by recognizing by pattern. As functions executed in the display device increase, it is difficult to display all icons and menus on one page because there are too many icons and menus displayed in the display device. Accordingly, it is advantageous that a user method to turn a page or menu is intuitive and convenient for the user without instructions when a touch signal in the horizontal direction is recognized as a pattern to turn a page or menu if turning page or menu is needed.

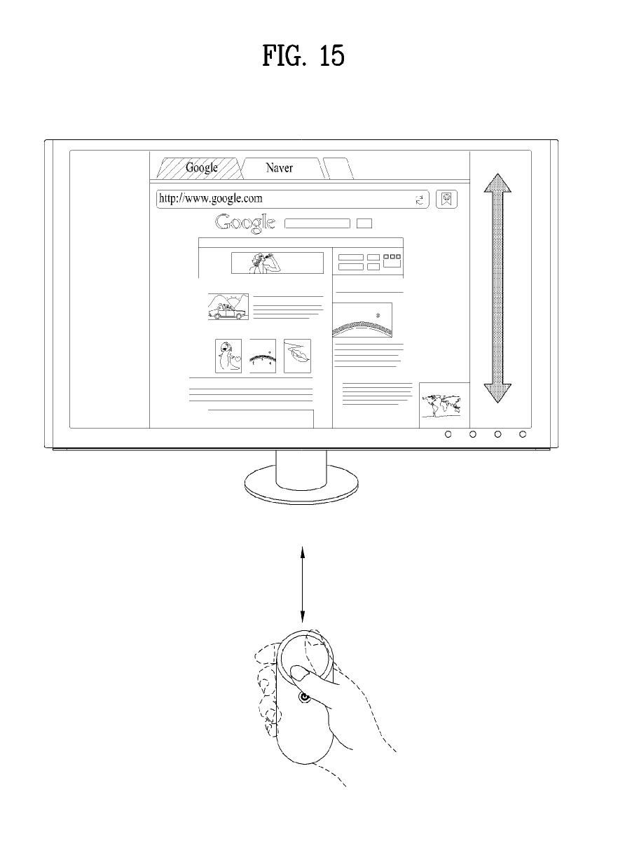

FIG. 15 is a view illustrating an embodiment of sensing a screen page control signal scrolling a page by recognizing a touch signal in the vertical direction as a pattern. As the internet function is added in the display device, web-surfing is possible and there are many occasions for the scroll function. Thus, it is advantageous to set a control signal similar to up and down scroll movements on the screen for the user because it is intuitive and convenient.

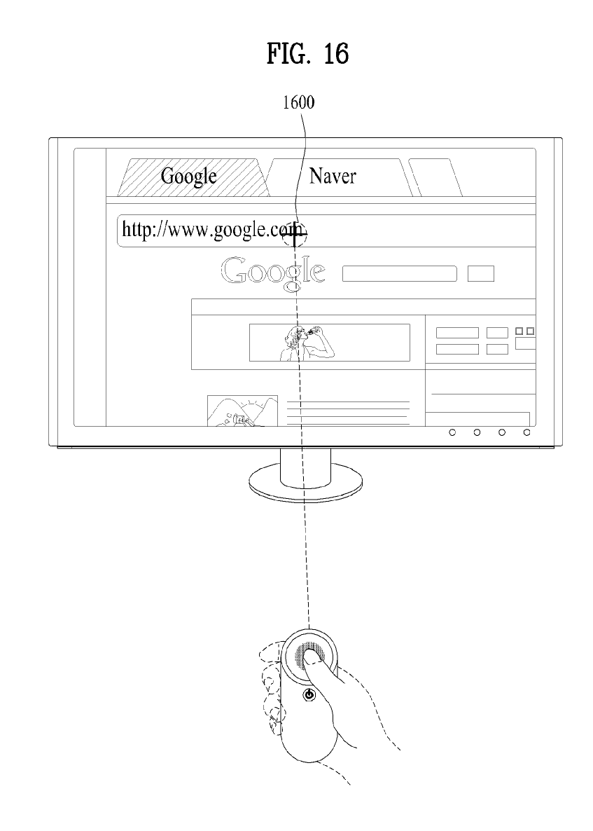

FIG. 16 is a view illustrating an embodiment sensing a zoom control signal of the screen by recognizing the touch signal pressing twice as a pattern. When the touch signal pressing twice on the screen in FIG. 15 is sensed, as shown in FIG. 16, the screen will be zoomed in and display a zoomed-in mark (1600) so that the user can intuitively come to know.

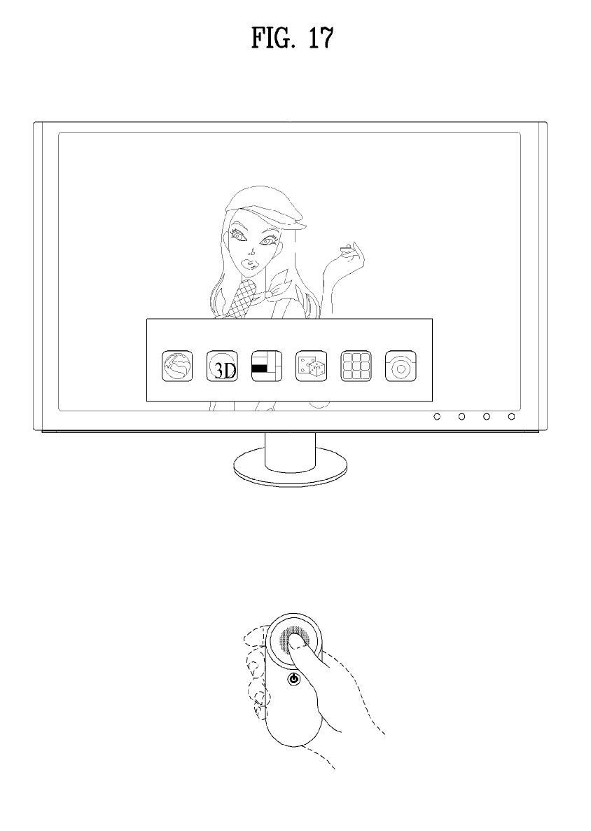

FIG. 17 is a view illustrating an embodiment of sensing a capture control signal of the screen by recognizing the touch signal pressing once as a pattern. As shown in FIG. 17, it is advantageous that the user can consistently apply control in overall as the control signal of the remote controller for the display device similar to the touch signal in the mobile device is used.

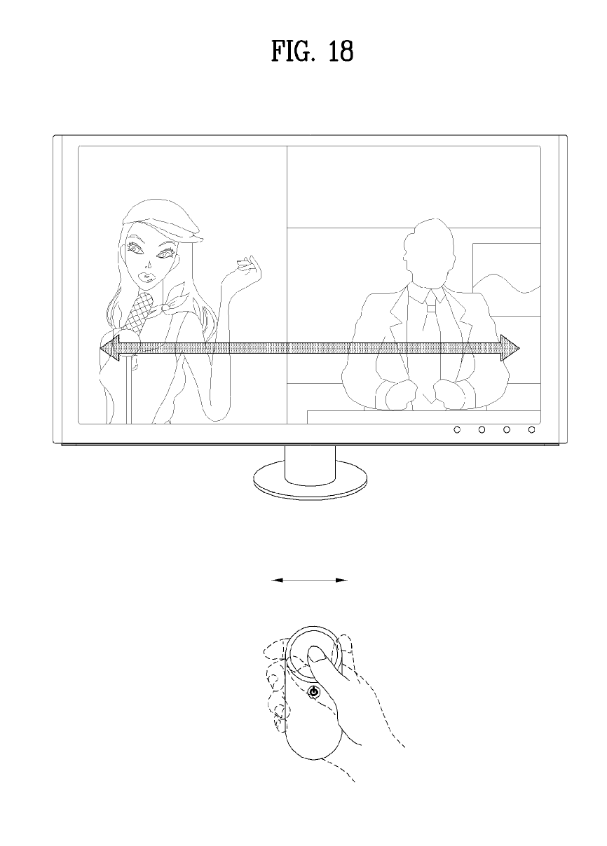

FIG. 18 is a view illustrating an embodiment of sensing a channel-change control signal by recognizing a touch signal in the horizontal direction as a pattern. As shown in FIG. 14, the touch signal in the horizontal direction can be sensed as a screen page control signal but concerning the user's intention it is more adequate to sense it as a channel-change control signal when the display device performs broadcast functions.

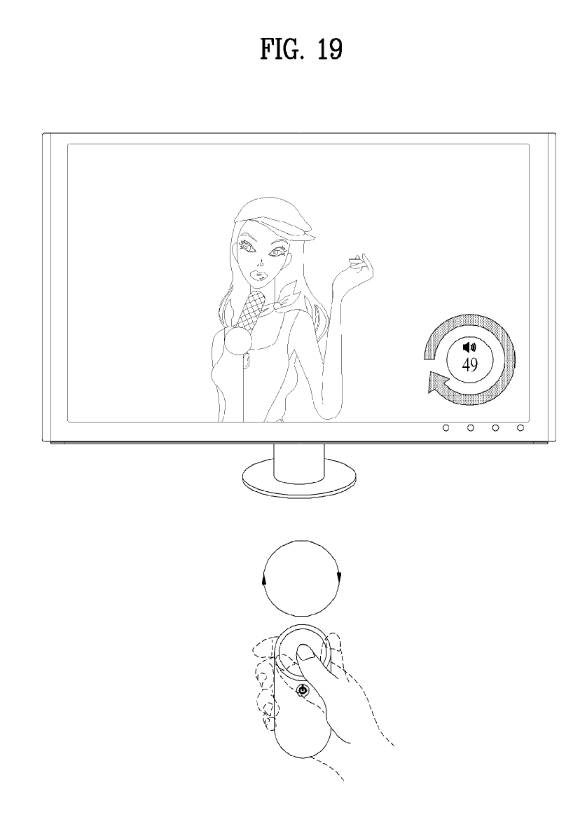

FIG. 19 is a view illustrating an embodiment of sensing a volume-change control signal by recognizing a touch signal drawing a circle as a pattern. In case of volume-change, it is good to have direction because volume needs to increase or decrease. Also, it is advantageous that the user can be provided with more intuitive and convenient conditions as the pattern direction is identical to a graphic user interface (GUI) shown on the screen in FIG. 18.

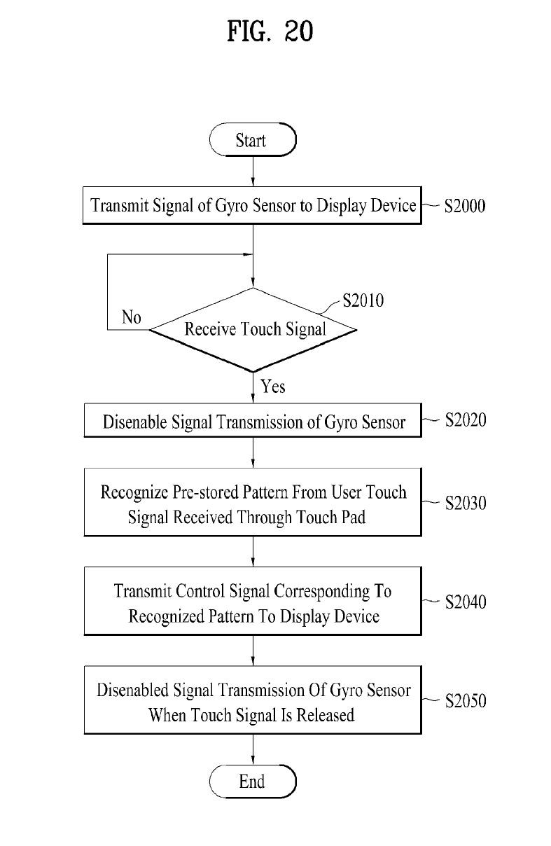

FIG. 20 is a flowchart of a control method of a remote controller equipped with a touch pad according to an embodiment of the present invention and the detailed description of matters identical to the matters of the remote controller equipped with the touch pad will be omitted.

A gyro sensor signal embedded in a remote controller is transmitted to a display device (S2000). The display device may indicate the movement of a pointer corresponding to the remote controller by the received gyro sensor signal, that is, by using the location value information of the remote controller.

Yet, it is continuously detected if the user receives a touch signal touching the touch pad (S2010). When a touch signal is received by sensing statics, the signal transmission of the gyro sensor is disenabled (S2020). If the touch signal and gyro sensor signal are jointly transmitted to the display device, the signal transmission of the gyro sensor is disenabled when the touch signal is created, in order to reduce side effects such as the user's unintentional selection of a different area.

Therefore, only the touch signal is transmitted to the display device and when the touch signal restores, the gyro sensor signal is transmitted to the display device again by restoring the disenabled signal transmission of the gyro sensor.

According to an embodiment, in the step of S2020, it can be set such that the gyro sensor signal can be disenabled after a predetermined period of time after statics is detected and the touch signal is received. The pointer corresponding to the remote controller touches the touch pad at the end corner of a desired menu of the display device, and it may be inconvenient that if the signal transmission of the gyro sensor is disenabled immediately, the gyro sensor may not be used because the point will be off the desired menu due to the horizontal and vertical shaking of the user hand. Therefore, the user may properly select the desired menu by using the gyro sensor staying for the predetermined period of time and delicately adjusting the location of the pointer.

On the other hand, the storage of the remote controller may store a receivable pattern through the touch pad and a control signal corresponding to the pattern. In case that such a pattern and control signal corresponding to the pattern are stored, the predetermined pattern is recognized in the user input signal received through the touch pad (S2030).

A control signal corresponding to the recognized pattern is transmitted to the display device, referring to the storage (S2040). The recognized corresponding control signal includes at least one of a power control signal of the display device, channel-change control signal, volume-change control signal, zoom control signal of a screen, capture control signal of the screen, and screen page control signal.

When the touch signal is disenabled, disenabling the signal transmission of the gyro sensor is restored (S2050) and transmits the gyro sensor signal to the display device again.

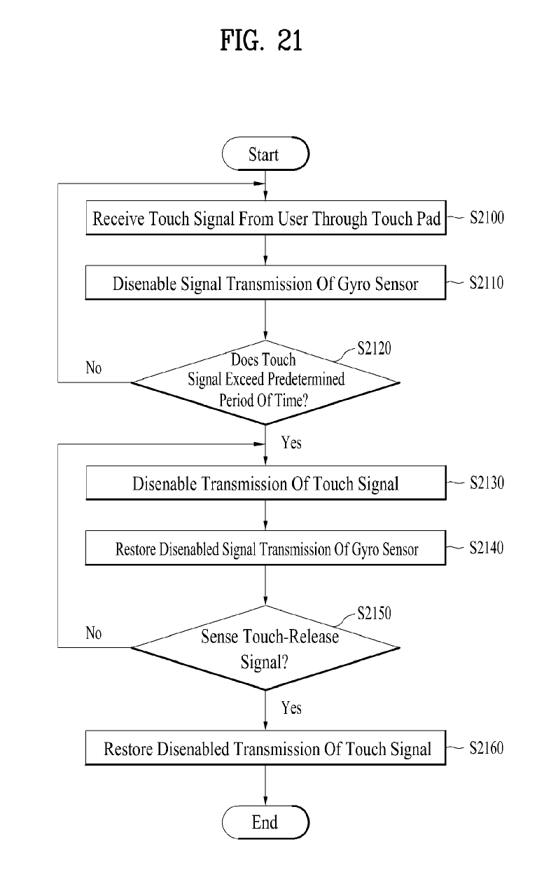

FIG. 21 is a flowchart of a control method of a remote controller equipped with a touch pad according to another embodiment of the present invention.

The touch signal is received from the user through the touch pad (S2100). In case that the touch signal and gyro sensor signal are transmitted to the display device, when the touch signal is created, the signal transmission of the gyro sensor is disenabled in order to reduce side effects such as the user's unintentional selection of a different area (S2110).

Yet, if the signal transmission of the gyro sensor is disenabled to the extent that the touch signal is consistently created for too long due to the user's habit, the user inconvenience may increase. Thus, it is determined whether or not the touch signal exceeds a predetermined period of time (S2120), and if it exceeds the predetermined period of time, it is determined that it is malfunctioned by the user's habit and the signal transmission of the touch signal is disenabled (S2130), and the disenabled signal transmission of the gyro sensor is restored (S2140).

In addition, continuously it is determined whether or not there is a touch-release signal by recognizing statics (S2150). When the touch-release signal is sensed, meaning that the touch signal which stayed over a predetermined period of time is restored, then the signal transmission of the touch signal is restored in order to transmit the touch signal again (S2160).

The present invention may be applied to disenabling or restoring the signal transmission of not only the gyro sensor but also other motion detecting sensors. The motion detecting sensor is a sensor such as a gyro sensor and accelerator sensor sensing operations or movements of a remote controller when the user uses the remote controller.

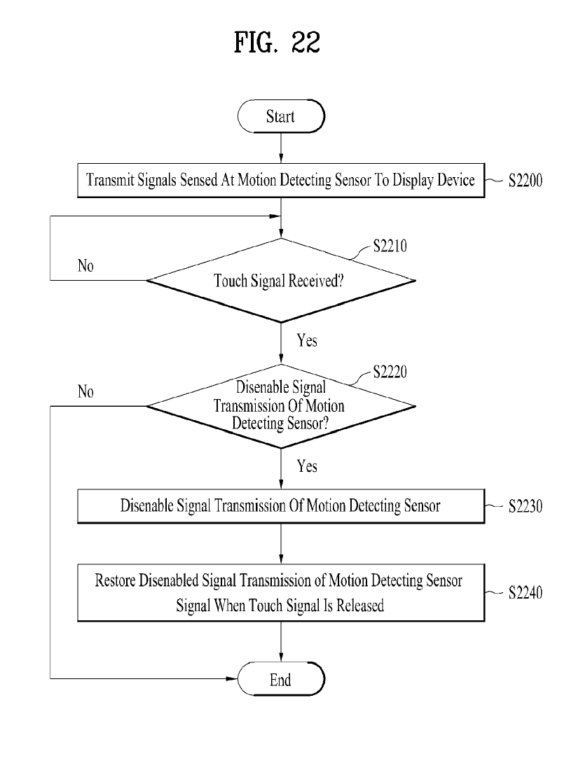

FIG. 22 is a flowchart of a control method of a remote controller equipped with a touch pad according to another embodiment of the present invention. The detailed description of matters identical to the matters of the remote controller equipped with the touch pad will be omitted.

The signal sensed in the motion detecting sensor embedded in the remote controller is transmitted to the display device (S2200). The display device may display the motion of the pointer corresponding to the remote controller by the received signal of the motion detecting sensor, that is, using the location value information of the remote controller.

Yet, it is continuously detected whether the user receives the touch signal touching the touch pad (S2210). In case that the touch signal is received by detecting statics, the user is asked whether transmitting the motion detecting sensor signal is disenabled (S2220).

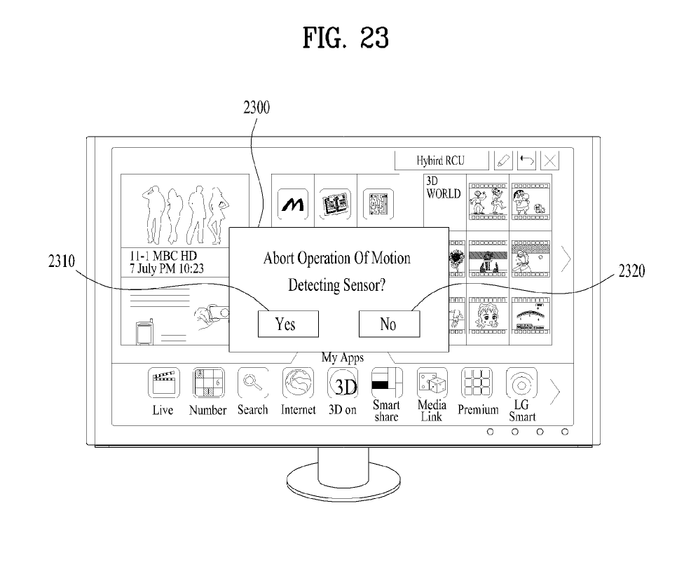

FIG. 23 is a view illustrating an embodiment of an information message window which can be applied to the flowchart of a control method shown in FIG. 22.

The controller of the remote controller, when the touch signal is received from the touch pad, transmits an information message of whether or not transmitting the motion detecting sensor signal will be disenabled to the display device through the wireless communications unit and outputs an information message window (2300) in the display device.

The information message window (2300) outputted in the display device may invite the user to decide whether the operation of the motion detecting sensor should be aborted or stay.

The information message window (2300) may be displayed with the screen outputted in the display device when the touch signal of the touch pad is received.

When the user selects a Yes button (2310) through the pointer corresponding to the remote controller, the controller of the remote controller disenables the signal transmission of the motion detecting sensor (S2230) and only the touch signal will be transmitted to the display device.

When the touch signal is restored, the disenabled signal transmission of the motion detecting sensor (S2240) will be restored and the motion detecting sensor signal will be transmitted to the display device again.

On the other hand, when the user selects a No button (2320) in the information message window (230), the touch signal and motion detecting sensor signal will be transmitted to the display device.

FIG. 24 is a flowchart of a controlling method of a remote controller equipped with a touch pad according to another embodiment of the present invention. The detailed description of matters identical to the matters of the remote controller equipped with the touch pad will be omitted.

A signal sensed in the motion detecting sensor embedded in the remote controller is transmitted to the display device (S2400). The display device may display the motion of the pointer corresponding to the remote controller by the received signal in the motion detecting sensor, that is, by using the location value information of the remote controller.

Yet, it is detected whether a first signal is continuously received from the touch pad (S2410). Here, the first signal means a signal indicating the “disenable” status of the motion detecting sensor. The first signal is different from a touch signal generated as the user simply touches the touch pad and a specified signal indicating the “disenable” status of the motion detecting sensor may be pre-stored in the storage of the remote controller.

FIG. 25 is a view illustrating an embodiment of a first signal which can be applied to a remote controller according to the present invention. Yet, FIG. 25 is not limited as an embodiment and the first signal may be set differently and added.

Referring to FIG. 25(a), in case of touching the touch pad for a predetermined period of time (t), that is, the touch signal that continues for the time t may be called the first signal. Or, as shown in FIG. 25(b), the touch signal corresponding to a specified pattern inputted in the touch pad may be determined as the first signal. In FIG. 25(b), although a specified pattern moving in the diagonal direction on the user's touch pad is illustrated, various patterns such as patterns in the horizontal, vertical directions, and a circular pattern may be set as the first signal. Or, as shown in FIG. 25(c), a touch signal selecting a specified menu (M) by using a pointer corresponding to the remote controller may be determined as the first signal.

When the first signal is received from the touch pad, transmitting the motion detecting sensor signal is disenabled (S2420). That is, the controller of the remote controller, when the first signal indicating the “disenable” status of the motion detecting sensor is detected, controls such that the signal sensed in the motion detecting sensor may not be transmitted to the display device. Because the user may feel inconvenient when the signal transmission of the motion detecting sensor is disenabled, as opposed to the user's intention, every time the touch pad is touched, according to the present invention, the signal transmission of the motion detecting sensor is disenabled only if the pre-stored specified first signal is received.

And, it is continuously detected whether or not a second signal can be received from the touch pad (S2430). Here, the second signal means a signal indicating the “enable” status of the motion detecting sensor. The second signal is different from a touch signal created by the user's simply removing the user's hand from the touch pad, and a specified signal indicating the “enable” status of the motion detecting sensor may be pre-stored in the storage of the remote controller.

An embodiment of the second signal may be described referring to FIG. 25(a) again. That is, a touch signal created when the touch pad is not touched for the predetermined period of time (t), as shown in FIG. 25(b), a touch signal corresponding to a specified pattern inputted in the touch pad, and, as shown in FIG. 25(c) a touch signal selected by using the pointer corresponding a specified menu (M) equipped in the screen of the display device to the remote controller may be set as the second signal.

The first and second signals may be set as the same type. For example, if touching the touch pad for the predetermined period of time (t) is the first signal, not touching the touch pad with the signal transmission of the motion detecting sensor disenabled for the predetermined period of time (t) may be set as the second signal. Or, if inputting a specified pattern in the touch pad is the first signal, inputting a specified pattern with the signal transmission of the motion detecting sensor disenabled may be set as the second signal. Then, the specified pattern corresponding to the first signal and the specified pattern corresponding to the second signal may be the same or different. Or, if a signal selecting the specified menu (M) in the screen of the display device is the first signal, re-selecting the specified menu (M) with the signal transmission of the motion detecting sensor may be the second signal. However, setting the first and second signals the same is only an embodiment and the present invention is not limited to such an embodiment.

When the second signal is received, the disenabled signal transmission of the motion detecting sensor is restored (S2440) and the signal of the motion detecting sensor may be transmitted to the display device again. That is, the controller of the remote controller, if the second signal indicating the enable status of the motion detecting sensor is detected, controls such that the sensed signal in the motion detecting sensor is transmitted to the display device again.

Moreover, although drawings are divided for convenient explanation, embodiments illustrated in each drawing are capable of designing such that new embodiments can be realized. And, depending on the user's necessity, designing a recording entity that can read program records to execute the illustrated embodiments is within the scope of the present invention.

Not only a remote controller and a controlling method according to the present invention are applied to the illustrated embodiments limited but also other various modified embodiments may be comprised by selectively using all or part of the embodiments.

On the other hand, a control method of the remote controller according to the present invention is capable of realizing a code that can be read by a processor equipped in a network device. The memory entity that the processor can read includes all kinds of memory device that stores data readable by the processor. Examples of the readable memory entity are a ROM, RAM, CD-ROM, magnetic tape, floppy disk, and fiber data storage device, and also carrier wave types like transmission through internet is included. Also, the memory entity readable by the processor is distributed in the computer system connected by network and the code readable by the processor by the distribution method can be stored and executed.

Also, although the appropriate embodiments of the present invention are explained, the present invention is not limited only to the aforementioned specified embodiments, and it will be apparent to those skilled in the art that various modifications and variations can be made in the present invention without departing from the main point of the present invention which claims within the scope of its claims. Thus, such modifications and variations may not be individually interpreted without departing from the spirit or scope of the inventions.

And, in the present specification, an apparatus invention and a method invention are illustrated and the both inventions may be additionally supplemented, if necessary.

### [Device Name]

600 Remote Controller
610 Wireless Communication Unit
620 User Input Unit
630 Sensor Unit
640 Output Unit
650 Storage
660 Power Supply Unit
670 Controller

What is claimed is:

1. A remote controller having a touch pad, the remote controller comprising:
a wireless communication unit transmitting a signal to and receiving a signal from a display device;
a touch pad receiving a user input signal for controlling the display device;
a sensor unit comprising a motion detecting sensor and sensing information about motion of the remote controller;
a storage storing data necessary for operating or controlling the remote controller; and
a controller controlling, when the user input signal is received at the touch pad, the motion detecting sensor to disenable signal transmission in response to the user input signal.

2. The remote controller of claim 1, wherein the controller controls the motion detecting sensor to disenable the signal transmission by sensing a touch signal from the touch pad as the user input signal and controls the motion detecting sensor to restore the signal transmission by sensing a touch-release signal from the touch pad as the user input signal.

3. The remote controller of claim 2, wherein the controller controls, when a duration of the touch signal exceeds a predetermined period of time, the motion detecting sensor to restore the signal transmission and the touch pad to disenable a transmission of the touch signal.

4. The remote controller of claim 3, wherein if the transmission of the touch signal is in a disenabled state, the controller controls the touch pad to restore the transmission of the touch signal when the touch-release signal is sensed.

5. The remote controller of claim 2, the remote controller further comprises a pattern recognizing part recognizing a pattern from the touch signal received through the touch pad.

6. The remote controller of claim 5, wherein the storage unit stores a receivable pattern through the touch pad and a control signal corresponding to the pattern.

7. The remote controller of claim 6, wherein the control signal corresponding to the pattern comprises at least one of a power control signal of the display device, a channel-change control signal, a volume-change control signal, a zoom control signal of a screen, capture control signal of the screen, and a screen page control signal.

8. The remote controller of claim 1, wherein the controller controls the motion detecting sensor to disenable the signal transmission by sensing a first signal from the touch pad as the user input signal and controls the motion detecting sensor to restore the signal transmission by sensing a second signal from the touch pad as the user input signal.

9. The remote controller of claim 8, wherein the storage unit stores the first signal and the second signal.

10. The remote controller of claim 8, wherein the first signal is one of a touch signal from the touch pad during a predetermined period of time, a touch signal corresponding to a specified pattern inputted in the touch pad, and a touch signal when a specified menu in a screen of the display device is selected.

11. The remote controller of claim 8, wherein the second signal is one of a signal generated when a touch signal from the touch pad is not received during a predetermined period of time, a touch signal corresponding to a specified pattern inputted in the touch pad, and a touch signal when a specified menu in the screen of the display device is selected.

12. A method of controlling a remote controller having a touch pad, the method comprising:
transmitting a signal of the motion detecting sensor to a display device;
receiving a touch signal from the touch pad;
disenabling the signal transmission of the motion detecting sensor when the touch signal is received;
transmitting the touch signal to the display device; and
restoring the signal transmission of the motion detecting sensor when a touch-release signal is released.

13. The method of claim 12, the method further comprises controlling, when a duration of the touch signal exceeds a predetermined period of time, the motion detecting sensor to restore the signal transmission and the touch pad to disenable a transmission of the touch signal.

14. The method of claim 13, wherein if the transmission of the touch signal is in a disenabled state, the method further comprises restoring the transmission of the touch signal when the touch-release signal is received.

15. The method of claim 12, the method further comprises storing a receivable signal through the touch pad and a control signal corresponding to the pattern.

16. The method of claim 15, the method further comprising:
recognizing a predetermined pattern from the touch signal received through the touch pad; and
transmitting a control signal corresponding to the recognized pattern to the display device.

17. The method of claim 15, wherein the control signal corresponding to the pattern comprises at least one of a power control signal of the display device, a channel-change control signal, a volume-change control signal, a zoom control signal of a screen, a capture control signal of the screen, and a screen page control signal.

18. The method of claim 12, wherein after the step of receiving a touch signal from the touch pad, the method further comprises asking a user whether or not the signal transmission of the motion detecting sensor is disenabled.

19. The method of claim 12, wherein in the step of disenabling the signal transmission of the motion detecting sensor when the touch signal is received, the signal transmission of the motion detecting sensor is disenabled after a predetermined period of time is passed from receiving the touch signal.

20. A method of controlling a remote controller having a touch pad, the method comprising:
transmitting a signal sensed at a motion detecting sensor to a display device;
detecting a first signal indicating a disenabled state of the motion detecting sensor;
controlling, when the first signal is detected, the sensed signal at the motion detecting sensor not to be transmitted to the display device;
detecting a second signal indicating an enabled state of the motion detecting sensor; and
controlling, when the second signal is detected, to return to the step of transmitting the signal sensed at the motion detecting sensor to the display device.
